(19) United States
(12) Patent Application Publication
(10) Pub. No.: US 2026/0352639 A1
(43) Pub. Date: Nov. 5, 2026

(54) METHOD AND SYSTEM FOR PRIVACY-AWARE PACKET PROCESSING

(71) Applicant: Telefonaktiebolaget LM Ericsson (publ), Stockholm (SE)

(72) Inventors: Gregoire PHILLIPS, Sunnyvale, CA (US); Mischa DOHLER, Santa Clara, CA (US)

(73) Assignee: Telefonaktiebolaget LM Ericsson (publ), Stockholm (SE)

(21) Appl. No.: 19/125,386

(22) PCT Filed: Nov. 4, 2022
(86) PCT No.: PCT/IB2022/060645

§ 371 Date: Apr. 29, 2025

(51) Int. Cl. H04L 9/40

(52) U.S. Cl. CPC H04L 63/04; H04L 63/20

(57) ABSTRACT

Embodiments include methods, electronic device, and storage medium to enhance privacy in a network. In one embodiment, a method comprises: determining whether a packet supports privacy preservation based on a packet header of the packet, identifying one or more operations to be performed on the packet corresponding to a privacy policy of the packet based on the packet upon determining that the packet supports privacy preservation, the privacy policy indicating a level of data sharing privilege mapped to a setting configured for a user; and causing the one or more operations to be performed on the packet, where the one or more operations to be performed on the packet comprise a privacy preservation operation including implementation of a privacy preservation protocol in the network for the packet to comply with the level of data sharing privilege.

### TECHNICAL FIELD

Embodiments of the invention relate to the field of privacy preservation; and more specifically, to privacy-aware packet processing.

### BACKGROUND ART

Along with the popularity of cloud computing, abundant data from ordinary consumers has been transmitted and processed across cloud systems, including data that is sensitive and exposes privacy of these consumers. For example, a cloud system may routinely transmit and process data such as patient diagnostic data sets established by medical institutions and online transaction data sets collected by e-commerce enterprises. Cloud system providers scale their cloud infrastructures based on increased demands, and the resulting Hyperscaler Cloud Platforms (HCPs) are shared by many applications from various vendors. Data breach in such cloud infrastructures can be catastrophic to the privacy of these consumers.

Additionally, data uploaded to a cloud system by one consumer may violate privacy of someone else. For example, a picture taken by a consumer may show the whereabouts of a bystander, who may wish not to be identified from the picture when the picture is posted in a social media platform by the consumer. The unwitting violation of the privacy of others can be a liability to the consumer and the service providers that allow such violation to occur.

While standards, regulations, and techniques are available to provide a baseline of privacy guarantees, there are no comprehensive network-level solutions that provide consumers with end-to-end privacy protection to process their data at the privilege levels as they specify, to obfuscate information in their data that may violate the privacy of others, and/or to audit the data process to ensure the privacy protection in the network has been performed properly.

### SUMMARY OF THE INVENTION

Embodiments include methods, electronic device, and storage medium to enhance privacy in a network. In one embodiment, a method comprises: determining whether a first packet supports privacy preservation based on a first packet header of the first packet, identifying one or more operations to be performed on the first packet corresponding to a first privacy policy of the first packet based on the first packet upon determining that the first packet supports privacy preservation, the first privacy policy indicating a first level of data sharing privilege mapped to a first setting configured for a first user; and causing the one or more operations to be performed on the first packet, where the one or more operations to be performed on the first packet comprise a privacy preservation operation including implementation of a first privacy preservation protocol in the network for the first packet to comply with the first level of data sharing privilege.

In one embodiment, an electronic device comprises a processor and machine-readable storage medium that provides instructions that, when executed by the processor, are capable of causing the processor to perform: determining whether a first packet supports privacy preservation based on a first packet header of the first packet, identifying one or more operations to be performed on the first packet corresponding to a first privacy policy of the first packet based on the first packet upon determining that the first packet supports privacy preservation, the first privacy policy indicating a first level of data sharing privilege mapped to a first setting configured for a first user; and causing the one or more operations to be performed on the first packet, where the one or more operations to be performed on the first packet comprise a privacy preservation operation including implementation of a first privacy preservation protocol in the network for the first packet to comply with the first level of data sharing privilege.

In one embodiment, a machine-readable storage medium that provides instructions that, when executed, are capable of causing a processor to perform: determining whether a first packet supports privacy preservation based on a first packet header of the first packet, identifying one or more operations to be performed on the first packet corresponding to a first privacy policy of the first packet based on the first packet upon determining that the first packet supports privacy preservation, the first privacy policy indicating a first level of data sharing privilege mapped to a first setting configured for a first user; and causing the one or more operations to be performed on the first packet, where the one or more operations to be performed on the first packet comprise a privacy preservation operation including implementation of a first privacy preservation protocol in the network for the first packet to comply with the first level of data sharing privilege.

By implementing embodiments as described, privacy protection may be specified, orchestrated, and audited through a network, and such solution is scalable and interoperable with solutions offered by multiple vendors.

### BRIEF DESCRIPTION OF THE DRAWINGS

The invention may be best understood by referring to the following description and accompanying drawings that are used to illustrate embodiments of the invention. In the drawings:

FIG. 1 illustrates a privacy enhancing network infrastructure per some embodiments.

FIG. 2A illustrates a privacy policy table to store privacy policies per some embodiments.

FIG. 2B illustrates protocol/technique selection for privacy preservation per some embodiments.

FIGS. 3A-3B illustrate privacy policy labels in an IPv4 packet and an IPV6 packet, respectively, per some embodiments.

FIGS. 4A-4C illustrate header indication for privacy enhancement per some embodiments.

FIG. 5 illustrates interactions of feature reduction and causal/temporal feature selection modules and their internal components per some embodiments.

FIG. 6 is a flow diagram illustrating the operations to reduce feature based on a feature selection request per some embodiments.

FIG. 7 is a flow diagram illustrating the operations to identify causal and temporal relationship between selected features and key performance indicators (KPIs) based on a feature selection request per some embodiments.

FIG. 8 illustrates an electronic device implementing privacy enhancement per some embodiments.

FIG. 9 illustrates an example of a communication system per some embodiments.

FIG. 10 illustrates a UE per some embodiments.

FIG. 11 illustrates a network node per some embodiments.

FIG. 12 is a block diagram of a host, which may be an embodiment of the host of FIG. 9, per various aspects described herein.

FIG. 13 is a block diagram illustrating a virtualization environment in which functions implemented by some embodiments may be virtualized.

FIG. 14 illustrates a communication diagram of a host communicating via a network node with a UE over a partially wireless connection per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein, refers to any positive whole number of items including one item.

### Privacy Enhancing Network Infrastructure

The viability of today's and tomorrow's internet hinges on the ability to provide security and privacy assurances. Cybersecurity is provided at every layer of the OSI communications stack, e.g., by encrypting data over the air interface, over the network, and at application level. Privacy, on the other hand, is solely handled through the acceptance (or rejection) of privacy terms & conditions (T&Cs) at the application layer today with little to no oversight, enforcement, or audit.

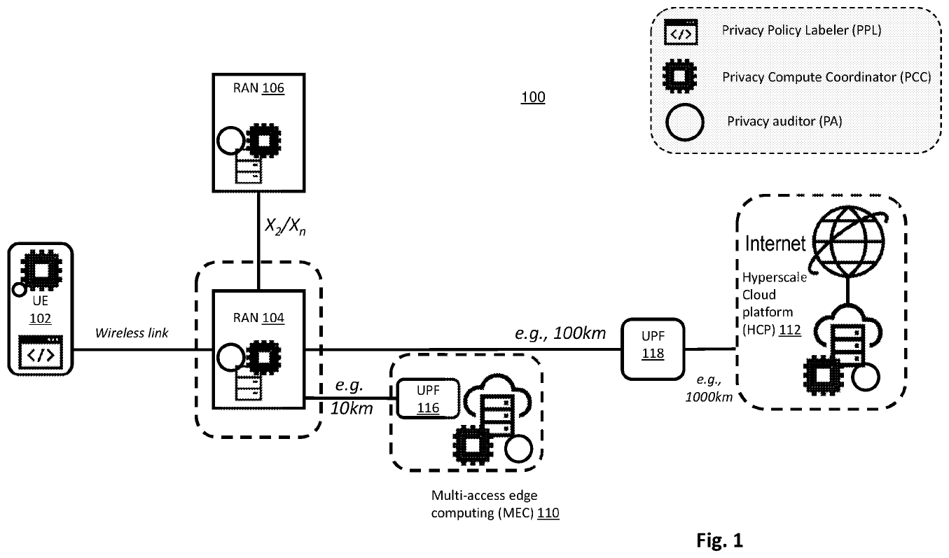

Embodiments of the invention operate over a network to enhance privacy protection of end users of the network. FIG. 1 illustrates a privacy enhancing network infrastructure per some embodiments. An end user may use a user equipment (UE) 102 to interact with the rest of the system 100. While only one UE is shown in the figure, multiple UEs may be coupled to the rest of the system 100 to exchange data and share information.

The end users of the UEs include consumers of the system 100, and they have their specific privacy preferences, which may be indicated as their service agreement with the operator of the network coupled to the UEs, and/or set in specific applications that the end users run. While a UE may not be operated by a human end user thus not corresponding to a consumer, such UE may still have a specific set of privacy preferences. In the context of privacy preservation, the terms of “end users” and “consumers” are used interchangeably herein.

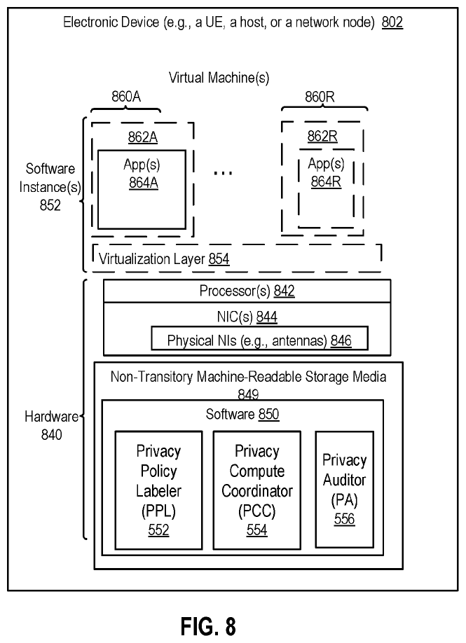

At UE 102, packets are explicitly labeled with a privacy policy by a privacy policy labeler. The privacy policy labeler (PPL) may be a software module as shown in FIG. 8 or a hardware logic/circuit within UE 102. The privacy policy label indicates a privacy policy and is inserted into a packet that is to be processed at UE 102 and transmitted to another electronic device, e.g., one in the radio access network (RAN) 104 through a wireless link. The packets may be Internet Protocol (IP) packets in some embodiments. In alternative embodiments, the packets may be ones transmitted at a higher layer (e.g., at the application layer or the transmission control protocol (TCP) layer in the open systems interconnection (OSI) model or equivalent) or lower layer (e.g., at the medium access control (MAC) layer in the OSI model or equivalent). While the IP packets are used as an example to discuss the privacy policy label insertion, embodiments of the invention are applicable to inserting the privacy policy label into packets/frames at other layers.

These privacy policy labels are known to privacy compute coordinators (PCCs) and privacy auditors (PAs) in system 100. For example, each of the PPLs, the PCCs, and the PAs may maintain the same table that maps a label to a protocol/technique, so the PCCs and PAs may perform the operations that are selected by the PPLs as indicated by the privacy policy labels. The maintaining and synchronization of the table within the PPLs, the PCCs, and the PAs may be performed within system 100 in an encrypted channel in some embodiments.

A privacy policy may contain indications/instructions for the processing of data in accordance with one or more protocols/techniques. This privacy policy indicates a first level of data sharing privilege and may be chosen for an end user and by (1) the end user, (2) the application provider that provides the application that the end user runs, (3) the operator managing the UE from where the application is run, (4) the communication/internet service providers (CSP/ISPs) providing the network on which packets of the application are transmitted, (5) the original equipment manufacturer (OEM) of the UE, and/or (6) another party. Additionally/alternatively, the privacy policy may be selected for the end user in accordance with the functions of the application or service (as consented to by the end user). The privacy policy may be securely stored on the end user device (e.g., UE 102), and/or in the network. Each end user device may store multiple privacy policies for different applications and different end users that run these applications. A user profile may specify a privacy policy that is applicable to a particular end user in a particular application, and the user profile may follow the end user to interact with different UEs.

A privacy policy indicates a privacy preference. For example, an end user may be running an application that shares features of the end user's locally modeled behavior with a global server, where the features are subjected to a series of aggregation and transformation functions in line with a privacy-preserving federated learning architecture for privacy-preserving model aggregation at the global server. The end user has consented to this privacy policy when agreeing to the application's terms and conditions, and the data of the end user may thus be aggregated, but without disclosing the privacy information of the end user, based on the privacy policy.

The privacy policy may be set at the traffic flow level. A traffic flow (also referred to as flow) may be defined as a set of packets whose headers match a given pattern of bits. A traffic flow may be identified by a set of attributes embedded to one or more packets of the flow. An exemplary set of attributes includes a 5-tuple (source and destination IP addresses, a protocol type, source and destination TCP/UDP ports). In the example of the last paragraph, the privacy policy may be set for the traffic flow generated in the application when UE 102 runs the application for an end user with a particular user profile. Alternatively, the privacy policy may be set to the UE level so that all the packets originated from UE 102 are set to follow the same privacy policy; or the privacy policy may be set at the packet level, where only a subset of packets in a traffic flow is to comply with the privacy policy.

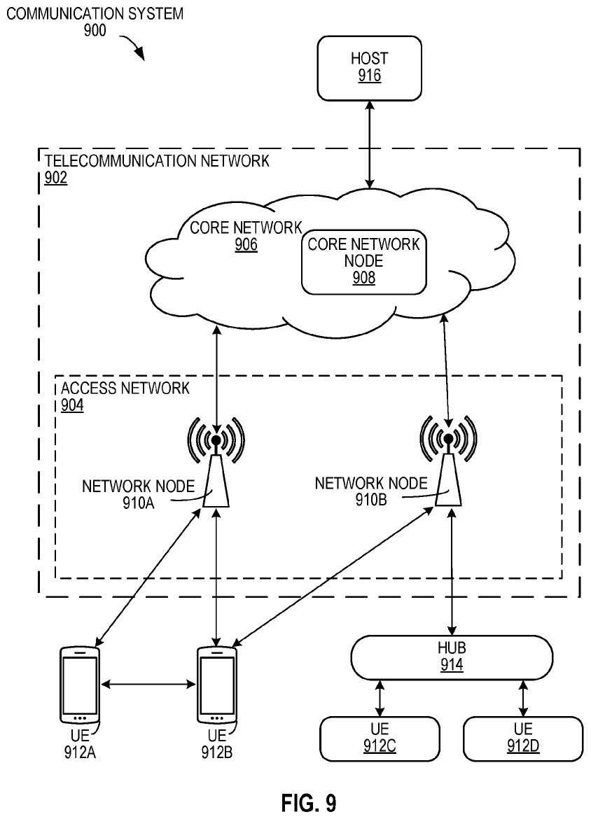

The packets with an indicated privacy policy are then processed in the network. The network may include access network and core network as shown in FIG. 9, and these networks are represented in FIG. 1 by RAN 104 and RAN 106, which are communicated through one or more X2 or Xn interfaces defined in the Long-Term Evolution (LTE) and the fifth generation (5G) standards. Each RAN may include one or more privacy compute coordinators (PCCs) and/or privacy auditors (PAS).

In some embodiments, a PCC and/or PA may be implemented in User Plane Function (UPF) module (e.g., UPF 116 and UPF 118) or a module within a Hyperscale Cloud Platform (HCP) 112, which is coupled to Internet. In other words, the PCC and/or PA may be implemented in one or more network nodes through which the packets with the indicated privacy policy may be processed (e.g., core network node 908 and/or access network nodes 910A-B as shown in FIG. 9). The UEs and network nodes of the system 100 may be located at different physical locations and FIG. 1 shows the geographic distances between difference entities as examples.

In some embodiments, the PCC and/or PA may be implemented in a multi-access edge computing (MEC) module 110, which may be implemented in a network node that is on the network edge and that analyzes, processes, and stores data. In this infrastructure, the MEC module may implement PCC and/or PA.

A privacy compute coordinator (PCC) coordinates the distribution and processing of the packets with an indicated privacy policy in the system 100, with another PCC, a PPL, and/or a PA. In some embodiments, the coordination is performed to enhance privacy in one or more of three types of operations on packets: packet distribution, packet processing, and packet auditing, each of which is explained below.
(1) Packet distribution: The PCC may distribute packets to network nodes that implement servers that meet the privacy policies specified by the packets. For example, an indicated privacy policy may require data within packets to be processed under a split-server architecture, such as under a secure multi-party computation (MPC) protocol for machine learning or remote localization/mapping.

Secure MPC implements cryptography that seeks to allow two or more parties to securely perform operations on confidential data without revealing any features of that data to collaborators. Such privacy policy may require the data to be transmitted only to servers that meet specific requirements pertaining to the required security assumptions. For example, these servers are required to be audited, monitored, or regulated in such a way that they cannot exchange their designated share of secret information with other servers containing some critical threshold of remaining secret information to cause the underlying identifiable information to be revealed. The servers that can't be audited, monitored, or regulated to maintain the confidentiality of the data are excluded from being selected to implement the secure MPC.

Some secure MPC protocols are secure under a passive model (also called semi-honest threat model), but may need some additional features (auditing capabilities, etc.) to reach for malicious threat model standards, where an adversary does not follow protocol and seeks to do harm by doing something like injecting bad data into the process. Other secure MPC protocols are implemented in an active model where the adversary may seek to do harm. Additional secure MPC protocols may be implemented in a fail-stop model in which the adversary may only make the semantic mapping computation crash without compromising the data privacy. Embodiments of the invention are not limited by a particular type of secure MPC protocol.

In some embodiments, the packet distribution requirement may be indicated by a transit label included in the packet. The PCC evaluates the transit label of a packet to determine how to route the packet to the appropriate servers in the network.
(2) Packet processing: The PCC may cause the packets to be processed to meet the privacy policies specified by the packets. For example, an indicated privacy policy requires data to be processed in such a manner as to not violate the privacy of a bystander who is captured in a picture (or a video), the data of which is included in a packet. The PCC may forward the packet to a network node that implements a server that may process the packet to obfuscate/remove the identifiable features of the bystander in the picture (e.g., facial features) and allows the updated packet to continue on in the network. For another example, an indicated privacy policy may require certain privacy information to be obfuscated, e.g., timing information of a packet, personal data relating to the end user whose corresponding UE generates the packet. The PCC may forward the packet to another network node that implements another server that may process the packet to obfuscate/remove the privacy information.

The PCC may also evaluate information relevant to sending packets to terminal locations of the HCP processing the data. This information includes the timing and/or manner in which the data should be processed at the processing location. Life cycle management is a critical component of key privacy provisions in regulations such as general data protection regulation (GDPR), where specific provisions provide the right for individuals to demand or consent to waive the right for their data to be stored for only specific quantities of time—after which it must be re-evaluated or removed/deleted. Thus, tracking and evaluating time in which the data is being processed/stored within the HCP could be an important privacy condition. Based on the timing information, the PCC may determine where to send the packets. About the manner to process packets, the label of a packet may indicate that the packet should be duplicated and sent to several different terminal HCP locations for processing thus enabling joint processing on encrypted or processed data across multiple servers, or that some pre-designated segment of the information should be sent to a third-party server to comply with the privacy preservation requirements.

In some embodiments, the packet processing requirement may be indicated by a processing label included in the packet. The PCC evaluates the processing label of a packet to determine how to route the packet to the appropriate servers in the network.
(3) Packet auditing: The PCC may generate an audit protocol for the returned processed information in packets to ensure that the proper privacy preservation processing is performed.

This audit protocol is associated with the packets involved in the requested privacy policy and is later used by the privacy auditors (PAs) to conduct the specified operations in compliance with the employed privacy enhancing technology.

In some embodiments, the packet audit requirement may be indicated by an auditing label inserted in the packet by a PPL. The PCC evaluates the auditing label of a packet to determine the proper audit protocol. Additionally/alternatively, the PCC may determine the audit protocol based on the type of processing performed (e.g., as specified in the processing label).

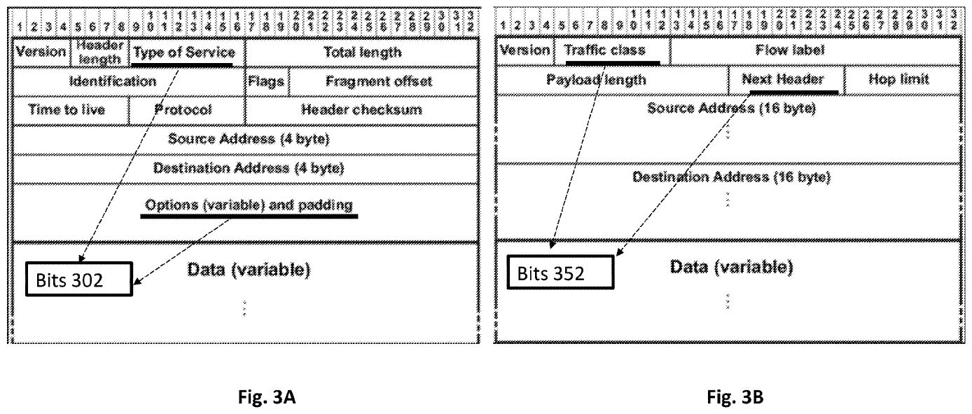

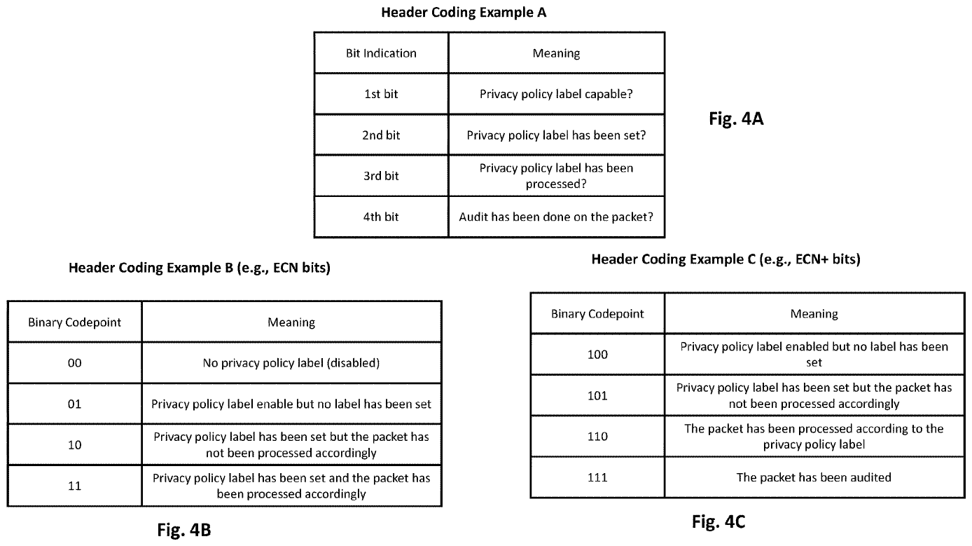

The transit label, the processing label, and the auditing label are referred together as privacy policy label. The privacy policy label may be indicated through a set of bits as pre-reserved in a packet. While in some embodiments a packet may include separate transit label, processing label, and auditing label, alternative embodiments may have one label indicating the two or more of the distribution operation, processing operation, and auditing operation. Additionally, each privacy policy label may include multiple parts in different fields of a packet. For example, one part of a privacy policy label may be in the header, while the other part of the privacy policy label may be in the payload. Furthermore, one label may indicate other packet processing features along with the privacy policy label. For example, a field may include bits to indicate one privacy policy label as well as bits to indicate Quality-of-Service (QoS) requirement for processing the packet or congestion, where these bits for QoS and congestion are to be set when a packet experiences congestion. FIGS. 3 to 4 describe more details about the labels.

A privacy auditor (PA) audits a packet with an indicated privacy policy to confirm the packet distribution and processing performed on the packet indeed complies with the indicated privacy policy. In some embodiments, the audit is performed (1) prior to the packet being transmitted to another end-user, (2) at certain checkpoints within the network, including the cloud system on the HCP 112, and/or (3) prior to the packet being returned to the end user (e.g., data with location information removed may be returned to the end user for storage with privacy preserved). If the audit is passed, the PA may provide an affirmative indication (e.g., inserting the indication in the packet) so that the packet may be further transmitted in the system 100. If the audit is failed, the PA may provide a failure indication, which may block the packet from transmitting to its designated destination (e.g., per destination address) and the packet may be routed for troubleshooting or be dropped. The incident may be reported to one or more of the end user, the application provider, the operator managing the UE, the CSP/ISPs, the UE OEMs (e.g., an alert message may be sent) and/or logged for mitigation and troubleshooting.

Through the coordinated operations by one or more privacy policy labelers (PPLs), privacy compute coordinators (PCCs), and privacy auditors (PAs), system 100 may provide an end user with enhanced privacy protection by (1) distributing packets of the end user's applications in the system, (2) processing these packets, and (3) auditing these packets as they are transmitted within the system, all based on the privacy policy for the end user.

Each of the PPLs, the PCCs, and PAs may be implemented as a software module of a UE, a network node, or a host (e.g., as shown in FIG. 8) or a hardware logic/circuit within the UE, the network node, or the host. In some embodiments, two or more of the PPL, the PCC, the PA are integrated as a single software module or hardware logic/circuit.

The privacy protection in embodiments of the invention follows the privacy by design principles: the architecture allows (1) end users (and/or others such as the application provider, the enterprise managing the UE, the CSP/ISPs, the UE OEMs) to specify a privacy policy for the end users' packets, and (2) a corresponding system to orchestrate its network nodes, hosts, and/or UEs to comply with the privacy policy and to audit the involved network nodes, hosts, and/or UEs to verify whether the involved parties have indeed caused the packets to comply with the privacy policy. The privacy protection in the embodiments, with its explicit goal of complying with an indicated privacy policy, provides protection of data that is additional and/or alternative to authentication via one or more symmetric/asymmetric cryptography keys at different interfaces and/or OSI layers (e.g., encrypting data over the air interface, over the network, and at application level).

Furthermore, the privacy protection in the embodiments is scalable to any number of networks (e.g., a few to hundreds or more RANs), and a network operator may even implement the privacy protection in a Hyperscale Cloud Platform (HCP). Additionally, the privacy protection in the embodiments may be implemented by multiple parties, which may interoperate easily based on the privacy policy labels. The privacy policy labeler (PPL), privacy compute coordinators (PCCs), and privacy auditors (PAS) may be implemented by different vendors at different locations in the system. In some embodiments, the audit operations are omitted; alternatively or additionally only one of packet distribution and processing is performed in some embodiments. In these cases, since the PPLs, PCCs, and PAs can be implemented separately by different vendors, it does not cause implementational difficulty and the remaining privacy preservation operations may still be performed without auditing and/or with only packet distribution/processing.

### Operations Relating to Privacy Policy Labels

As discussed, multiple privacy policies may be stored at an end user device (e.g., UE 102) and/or in the network. A user profile may specify a privacy policy that is applicable to a particular end user in a particular application. The user profile in an account of an end user, like a user profile in a social media platform, may include personal information about the end user and the social networks of the end user (e.g., “friends” and/or “connections” of the end user).

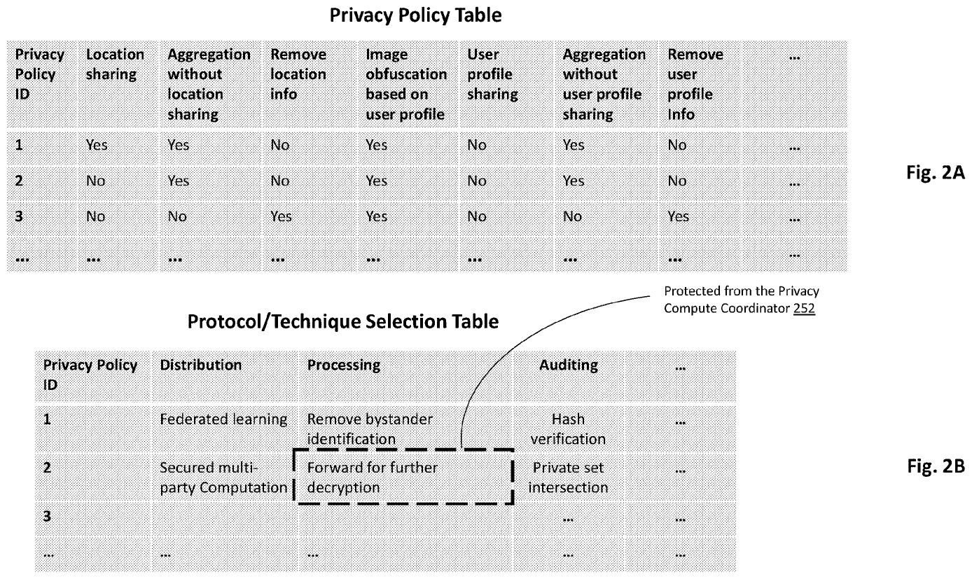

FIG. 2A illustrates a privacy policy table to store privacy policies per some embodiments. The privacy policy table may be stored at an end user device (e.g., UE 102 of FIG. 1 and UE 912A-D of FIG. 9), a network node (e.g., one of core network node 908, network nodes 910A-B of FIG. 9, and/or host 916 of FIG. 9). While a table is shown as an example, the privacy policies may be stored in a variety of data structures, such as a map, a dictionary, a list, an array, or a file. Further, the discussion of columns and rows within these tables is arbitrary; while one implementation may choose to put entries in rows it is trivial to modify the data structure to put entries in columns instead.

The privacy policy table includes privacy policies that are indexed by privacy policy identifiers (IDs), which may be implemented using numerical numbers in some embodiments. Each privacy policy may indicate a privacy setting. For example, the table shows the settings for the following: (1) whether location sharing is allowed (when set, a recipient of the packet with this privacy policy may be able to identify from where the data is transmitted/obtained); (2) when location sharing is not allowed, whether the location information may be aggregated (when set, a recipient of the packet with this privacy policy may not know the location information specifically but the location information of the packet may be aggregated with location information of other packets, and the location information in aggregation may help the recipient learn end user behaviors in aggregation without knowing the behavior of a particular user); (3) whether to remove location information or not (when set, the location information may be removed from the packet); (4) whether to obfuscate image data based on user profile or not (when set, mask/remove identifiable features of a bystander, who is not the end user or friends/connections of the end user (which may be determined based on the user profile that indicates the end user and friends/connections of the end user)); (5) whether user profile sharing is allowed (when set, a recipient of the packet with this privacy policy may be able to identify from whom the embedded data is transmitted); (6) when user profile sharing is not allowed, whether the user profile information may be aggregated (when set, a recipient of the packet with this privacy policy may not know from whom the embedded data is transmitted but the user profile information of the packet may be aggregated with user profile information of other packets, and the user profile information in aggregation may help the recipient learn end user behaviors in aggregation without knowing the behavior of a particular user); (7) whether to remove user profile information or not (when set, the user profile information may be removed from the packet).

These privacy settings of the privacy policies are for illustration only, and many more settings may be specified based on the preferences of the end user and/or resource limitations of the UE, the application provider, the operator managing the UE, the CSP/ISPs, the UE OEMs, the application/service in which the corresponding packets are generated, and other entities.

For a given application to be run by a particular end user, a privacy policy within the privacy policy table may be selected. In some embodiments, a default privacy policy is mapped to an application or end user. A privacy policy labeler (PPL) inserts a privacy policy label to a packet mapped to the selected/default privacy policy for the packet or the traffic flow of an application to which the packet belongs.

FIG. 2B illustrates protocol/technique selection for privacy preservation per some embodiments. Based on the selected/default privacy policy, the privacy policy labeler (PPL) may insert the mapped privacy policy label into a packet. As discussed, the privacy enhancement may be achieved through one or more of three types of operations on the packets: packet distribution, packet processing, and packet auditing, each of which may be mapped to a protocol/technique implementation that a label may indicate. For each type of operation, the PPL may determine a proper protocol/technique to implement based on the setting of the specific privacy policy.

The selected protocols/techniques may be summarized in a protocol/technique selection table as shown in FIG. 2B. The protocol/technique selection table shows PPL's selections in packet distribution, processing, and auditing for each privacy profile. Each entry in the protocol/technique selection table indicates protocol/technique selection for a privacy policy. More columns may be included in some embodiments, including application type and other information that may be used to map the protocol/technique selections. Each selection may be represented by a set of bits, which is the label that the PPL inserts into packets to indicate how the packets should be distributed, processed, and/or audited.

The PPL selects the protocols/techniques based on privacy policy settings (e.g., the ones shown in FIG. 2A). For example, the PPL determines that, for privacy policy #1, federated learning is the proper protocol to use for packet distribution, as the privacy policy #1 requires aggregation without location sharing as shown in FIG. 2A and federated learning may process data in aggregation without knowing the origin of the data.

In some embodiments, federated learning supports privacy preserving information exchange that uses masking at local parties and demasking at an aggregator through aggregating the masked local data. Each local party knows its own set of cryptographic keys to mask (referred to as a mask) and no other local parties nor the aggregator knows the set of cryptographic keys so that once a value is masked using the set of cryptographic keys (e.g., through encryption using the set of cryptographic keys), the other local parties and the aggregator can't decode the value. Yet the masks are designed so that the aggregation of the masks cancels out the masks, so that the aggregation of the masked values returns the aggregation of the values prior to the masking.

For packet processing, the PPL determines that the packet needs to be processed further to remove bystander identification as the privacy policy #1 indicates that image data obfuscation is required based on user profile as shown in FIG. 2A.

For packet auditing, the PPL determines that the result of the packet distribution and processing will be audited through hash verification based on the settings of privacy policy #1.

When a packet with an identified privacy policy is distributed and/or processed, a hash may be computed and stored in the packet to indicate the result of distribution and/or processing. A privacy auditor (PA) may check the hash and verify the hash value is the one expected from the selected distribution and processing protocols/techniques.

For privacy policy #2, the PPL determines that a secured MPC protocol is proper to use for packet distribution. The selected secured MPC protocol may be a passive model with specific parameters based on the privacy policy setting, e.g., Shamir secret sharing (n=6 and k=3, where n is the number of secret shares and k is the threshold to uniquely determine a polynomial of degree to reconstruct the secret).

For packet processing in privacy policy #2, the PPL further determines that the packet processing technique/protocol should be shielded from a privacy compute coordinator (PCC) and assigns a label accordingly to indicate to where the PCCs should forward the label to decryption. The PPL may encrypt the label corresponding to the packet processing with an additional/alternative layer of encryption to shield from the PCC as shown at reference 252.

A PCC that examines the packet will route the label portion to another entity (e.g., a server of a service provider) that is designated to decrypt such encrypted label. That is, the PPL will set the label so that the PCC knows how to route the packet for further decryption and processing without knowing the specific protocol/technique to be used to further process the packet. The other entity then processes the packet according to the label after decryption. A number of protocols/techniques may be used to encrypt the label by the PPL, route the label by the PCCs, and decrypt the label by the other entity, including confidential computing techniques, where data in use is protected by performing computation in a hardware-based Trusted Execution Environment (TEE). While the PPL encrypts the processing label only in this example, the PPL may encrypt the transit label and/or auditing label in addition or in alternative as well. In that case, the other entity will distribute and/or audit the packet instead of the PPL.

For packet auditing in privacy policy #2, the PPL may also determine that the result of the packet distribution and processing will be audited through private set intersection (PSI) based on the settings of privacy policy #2.

In some embodiments, a PSI is a secure multi-party computation (MPC) cryptographic technique that allows two or more parties holding sets to compare encrypted versions of these sets in order to compute the intersection. PSI protocols can be categorized into specialized and generic (the latter also called circuit-based) ones. Specialized PSI protocols rely on cryptographic building blocks such as Diffie-Hellman key exchange, blind-Rivest-Shamir-Adleman (RSA), El-Gamal encryption, Homomorphic Encryption (HE), Oblivious Transfer (OT), or Oblivious Pseudo-Random Functions (OPRFs) to securely compute nothing but the intersection itself. Generic PSI protocols utilize MPC protocols such as Yao's garbled circuits or the protocol by Goldreich, Micali, and Wigderson (GMW) that can securely evaluate Boolean circuits to determine the intersection. Besides computing the intersection, the generic PSI protocols may compute arbitrary functions on top of the intersection that might be of interest—without disclosing the intermediate intersection result. While the PSI is used as an example of audit techniques, another protocol/technique may be used to audit the packet that is processed through the additional/alternative layer of encryption.

The privacy policy labeler (PPL) may insert the privacy policy label into a packet for the protocol/technique selections of the packet to notify (1) a privacy compute coordinator (PCC) how to distribute and process the packet, and (2) a privacy auditor (PA) how to confirm that the packet has been properly distributed and processed. While FIG. 2B shows a few exemplary protocols/techniques such as federated learning, secured MPC, and PSI, many other protocols/techniques may be used, including differential privacy, confidential computing, and homomorphic encryption. These protocols/techniques may include different types/modes that a PPL may select for a privacy policy, and it is challenging to insert labels into a packet that represents the selected protocols/techniques in different categories (packet distribution, packet processing, and packet auditing) from the numerous protocols/techniques.

FIGS. 3A-3B illustrate privacy policy labels in an IPv4 packet and an IPV6 packet, respectively, per some embodiments. As discussed, a privacy policy label may include three different labels in some embodiments: transit label for packet distribution, processing label for packet processing, and auditing label for packet auditing, each represented by a set of bits.

These labels may be inserted into the packet header. For example, these labels may be inserted into the Type of Service (ToS) field or the options and padding field in the IPv4 packet as shown in FIG. 3A as three sets of bits in one or more fields. In the IPV6 packet, these labels may be inserted into the traffic class field, or the next header field as shown in FIG. 3B. Alternative embodiments may have one label indicated by a single set of bits within a field to indicate the two or more selected packet distribution, packet processing, and packet auditing protocols/techniques.

Yet the standard IP packet headers have limited bit positions available for optional usage, such as privacy enhancement. The limited bit positions reduce the possible selections of protocols/techniques to distribute, process, and audit packets when the privacy policy label is limited to the packet header. For example, each of the type of service in IPv4 header and the traffic class in IPv6 header has only eight bits, and a number of bits within the eight bits are already defined in standards and cannot be used for another purpose (see e.g., the Internet Engineering Task Force (IETF) Request for Comments (RFCs) 2474 and 2460).

In some embodiments, the privacy policy label is divided into two parts, one in the header and the other in the payload. The portion of the privacy policy label in the header indicates the status of the packet regarding privacy enhancement operations and the other portion in the payload (e.g., bits 302 and 352 in the IPv4 and Ipv6 packet payloads, respectively) indicates the corresponding label(s) to indicate how the packets are to be distributed, processed, and/or audited. In these embodiments, the bits 302 and/or 352 may include either (1) three sets of bits, each indicating one of the transit label, the processing label, and the auditing label; or (2) one or two sets of bits, the permutation of which indicates the selected protocols/techniques to distribute, process, and/or audit the packet. Note packet auditing may not be implemented in some embodiments, and thus only one or two sets of bits may be inserted in the packet payload. Based on the indication of the portion of the privacy policy label in the header, a privacy policy labeler (PPL), a privacy compute coordinator (PCC), and a privacy auditor (PA) receiving the packet may set and/or identify the other portion in the payload.

FIGS. 4A-4C illustrate header indication for privacy enhancement per some embodiments. In some embodiments, the portion of the privacy policy label in the header indicates the status of the packet regarding privacy enhancement operations.

FIG. 4A illustrates a four-bit implementation of the header indication per some embodiments. These four bits may be included in a single field or distributed among multiple fields in a packet header. The first bit indicates whether the packet is capable to support privacy enhancement based on a privacy policy label. The default is not to set the first bit in some embodiments. If the first bit is not set, the privacy policy labeler (PPL), the privacy compute coordinator (PCC), and the privacy auditor (PA) know that no privacy enhancement may be performed on the packet and may ignore the packet. The first bit may be set prior to the packet arriving at a privacy policy labeler (PPL) when a UE (or a network node/host) determines that privacy enhancement may be performed on the packet; otherwise, the first bit may be set by the privacy policy labeler (PPL) upon the determination.

When privacy enhancement may be performed, the privacy policy labeler (PPL) includes the other portion of the privacy policy label in the payload of the packet, at specified location (e.g., bits 302 or 352 in FIGS. 3A-3B) and sets the second bit, indicating that privacy policy label has been set.

The third bit indicates whether the packet has been examined and operated on by a privacy compute coordinator (PCC). If not set, the PCC that receives the packet may operate on the packet (packet distribution and/or processing). The operation is based on the other portion of the privacy policy label in the payload of the packet as that identifies the selected protocols/techniques for privacy enhancement. Once that's done, the PCC sets the third bit.

The fourth bit indicates whether an audit has been done on the packet by a privacy auditor (PA). If not set, the PA that receives the packet may audit the packet, and the audit is based on the other portion of the privacy policy label in the payload of the packet as that identifies the selected one or more protocol/technique for packet auditing. Once that's done, the PA sets the fourth bit.

FIG. 4B illustrates a two-bit implementation of the header indication per some embodiments. These two bits may be included in a single field or distributed among multiple fields in a packet header. In some embodiments, the two bits repurpose the two explicit congestion notification (ECN) bits. The ECN bits may be implemented as two contiguous bits within the type of service field in IPv4 header and traffic class field in IPv6 header. Instead of indicating congestion, the two bits indicate different states of privacy enhancement operations without auditing. As shown, “00” indicates no privacy policy label is enabled; “01” indicates privacy policy label has been enabled but no label has been set for the packet; “10” indicates that a privacy policy label has been set for the packet, but the packet has not been processed accordingly; and “11” indicates that the privacy policy label has been set for the packet and the packet has been processed accordingly. Of course, the mapping of statuses may differ in a different embodiment.

FIG. 4C illustrates a three-bit implementation of the header indication per some embodiments. These three bits may be included in a single field or distributed among multiple fields in a packet header. In some embodiments, the three bits repurpose the two ECN bits and the remaining bit that is unused in the differentiated services (DS) field (which is set to “0” in IETF standards).

In some embodiments, the unused bit in the DS field may be set to indicate that privacy policy label has been enabled for the packet. For example, the DS field takes the six most significant bit positions of the type of service field in IPv4 and traffic class field in IPv6. The last bit is unused, and it can be combined with the two ECN bits to indicate different states of privacy enhancement operations.

When the unused bit is not set, the packet is not enabled to support privacy enhancement based on a privacy policy label, and the privacy policy labeler (PPL), the privacy compute coordinator (PCC), and the privacy auditor (PA) know that no privacy enhancement may be performed on the packet and may ignore the packet.

When the unused bit is set, the PPL, PCC, and PA may operate according to the setting of the three bits. In this example, “100” indicates that privacy policy label has been enabled but no label has been set for the packet; “101” indicates that the privacy policy label has been set for the packet but the packet has not been processed accordingly; “110” indicates that the packet has been processed according to the privacy policy label; and “111” indicates that the packet has been audited. Of course, the mapping of statuses may differ in a different embodiment as well.

Implementing the privacy policy label into a header part and a payload part is advantageous. Such implementation allows not only more bits to indicate more possible options of protocols/techniques to be applied on the packet for privacy enhancement, but also more efficient packet inspection by the privacy policy labeler (PPL), the privacy compute coordinator (PCC), and the privacy auditor (PA), all of which may inspect only a few bits in the header to know the current status of the packet regarding privacy enhancement operations.

Additionally, an IP tunnel may be implemented to encrypt data over the air interface or over the network to enhance data security. Each IP packet in a tunnel has been provided with an IP tunnel header, an outer header. The IP tunnel header carries information which is copied from the IP packet headers. Thus, an outer header carries the current status of a packet regarding privacy enhancement operations that is in the IP packet, and thus the privacy policy labeler (PPL), the privacy compute coordinator (PCC), and the privacy auditor (PA) may determine the current status while maintaining the integrity of the IP tunnel. That makes data security and privacy enhancement work together more efficiently.

### Use Cases

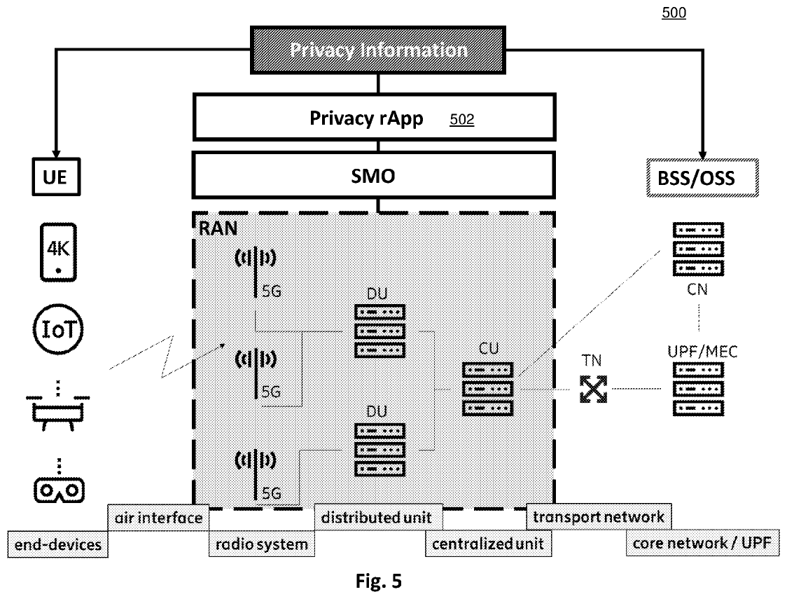

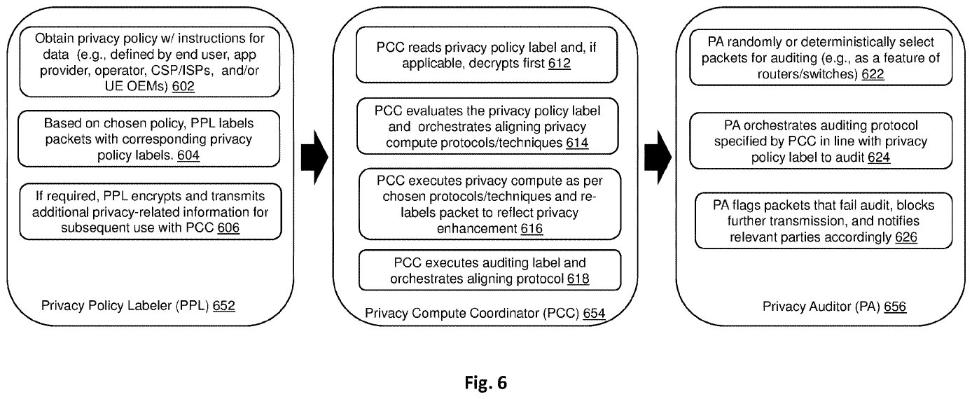

Privacy enhancement based on privacy policy label may be implemented in many use cases. FIG. 5 illustrates implemented privacy enhancement based on privacy policy label per some embodiments. The system 500 uses an open RAN (O-RAN) architecture, which includes an rApp dedicated to enhancing privacy, privacy rApp 502. An rApp is a self-contained application that may be provided by third parties, that consume one or more Non-Real-Time RAN intelligent controller (RIC) services and contain the intelligence to analyze and/or optimize the RAN.

The privacy information (e.g., user profiles regarding privacy, the meaning of different privacy policy labels and corresponding techniques/protocols, privacy policy IDs) are shared between UEs (different types of end devices are shown as examples of the UEs) and entities of operations support system and business support system (OSS/BSS), including core networks (CN) and UPF/MEC.

The privacy rApp 502 is managed by a Service and Management Orchestration (SMO) layer of the RAN, which includes 5G base stations, distributed units (DU), and centralized units (CUs) that communicate with CN and UPF/MEC through a transport network or not.

The privacy rApp 502 configures the RAN as per privacy requirement and may enable and disable the privacy enhancement based on the need and/or triggers. Additionally, the privacy rApp 502 enables and disables secure slice establishment (e.g., using Network Slice Selection Assistance Information (NSSAI) or deep neural network (DNN)) using credentials from privacy servers coupled with UE or BSS/OSS.

The privacy rApp 502 may operate to perform the operations of one or more of the privacy policy labeler (PPL), the privacy compute coordinator (PCC), and the privacy auditor (PA) discussed herein above.

For example, an end user may indicate a preference for any data revealing their location to be processed with a higher degree of privacy protections than other data. The privacy rApp 502 may translate this preference into an information-theoretic secure privacy protocol like MPC, and label data packets containing location data (acting as a privacy policy labeler (PPL)). The data packets would then be distributed and processed in the RAN by the privacy rApp 502 under a split-architecture MPC protocol—splitting the data at the network level and distributing to servers in line with the end user's and/or HCP's processing guidelines for processing data under MPC (acting as a privacy compute coordinator (PCC)). Once this computation is complete, an appropriate auditing protocol for the selected implementation of MPC is carried out by the privacy rApp 502 in line with the user's preferences (acting as a privacy auditor (PA)).

While the privacy enhancement may be performed on the application layer (e.g., the privacy rApp 502 in this example) in some embodiments, it may be performed within an operating system (OS) in addition or in alternative (e.g., the operations of the privacy rApp 502 may be performed within the Service and Management Orchestration (SMO) layer).

### Operations Per Some Embodiments

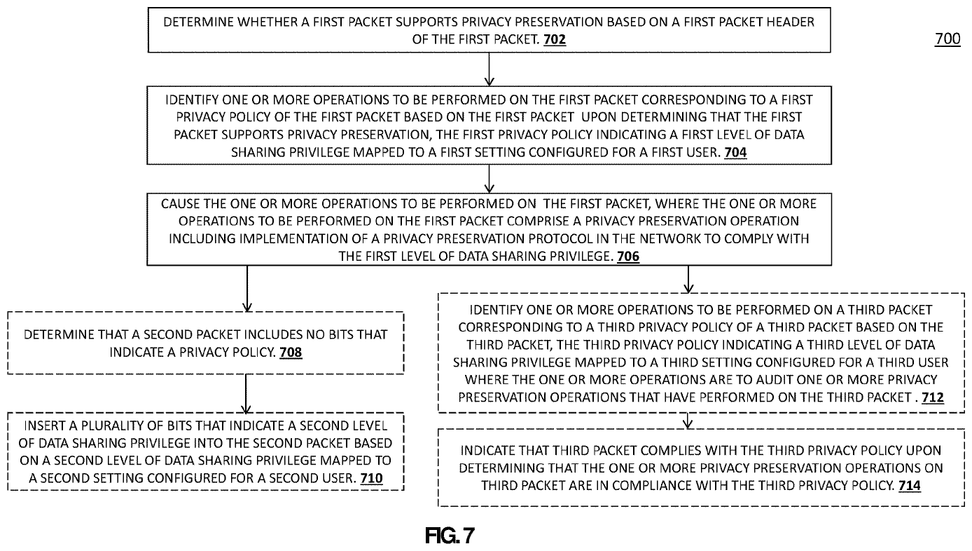

FIG. 6 illustrates operations performed by a privacy policy labeler (PPL), a privacy compute coordinator (PCC), and a privacy auditor (PA) per some embodiments.

A privacy policy labeler (PPL) 652 obtains a privacy policy with instructions for data, for example, defined by end user, the application provider, the operator managing the UE, the CSP/ISPs, and the UE OEMs at reference 602. A privacy policy may be chosen (or as default) for an application run by the end user. Based on the chosen policy, the PPL labels the packets of the application with corresponding privacy policy label at reference 604. If required, the PPL encrypts and transmits additional privacy-related information for subsequent use with a privacy compute coordinator (PCC) at reference 606. The encryption and transmission of the additional privacy-related information is to shield a certain label from the PCC as discussed herein above.

A privacy compute coordinator (PCC) 654 reads the privacy policy label inserted in a packet; and when the privacy policy label is encrypted (for transmitting the packets from the PPL to PCC without exposing privacy policy label), decrypts it first at reference 612. The PCC 654 then evaluates the corresponding privacy policy and orchestrates aligning one or more privacy computing protocols/techniques (e.g., for packet distribution and/or processing) at reference 614. For example, the PCC 654 may determine the servers to be used in a split-server architecture that meet the specific requirements for the aligning privacy computing protocols/techniques.

The PCC 654 executes privacy compute as per chosen one or more privacy computing protocols/techniques and relabels the packet to reflect privacy enhancement at reference 616. For example, the relabeling may be setting the third bit in FIG. 4A or update the binary codepoint in FIGS. 4B-4C.

When auditing is supported, the PCC 654 may also execute an auditing label and orchestrate an aligning protocol for auditing by a privacy auditor at reference 618.

Note that when the label-inserting PPL 652 decides that the chosen protocols/techniques shall be shielded from the PCC 654, additional encryption may be added, and the PCC 654 may route the label to another entity for decryption as discussed herein relating to FIG. 2B box 252.

A privacy auditor (PA) 656 may randomly or deterministically select packets of a traffic flow for auditing at reference 622. As a feature of a network node (e.g., a router or switch), the PA 656 may randomly sample the packets of the traffic flow or selected with certain pattern to perform the audit. At reference 624, the PA 656 orchestrates auditing protocol specified by PCC that is in line with the privacy policy label to audit the packets. The PA 656 further flags the packets that fail the audit, blocks those packets from further transmission, and notifies one or more relevant parties accordingly at reference 626.

FIG. 7 is a flow diagram illustrating the operations to enhance privacy protection per some embodiments. The operations may be performed by an electronic device including a privacy policy labeler (PPL), a privacy compute coordinator (PCC), and/or a privacy auditor (PA) in some embodiments.

At reference 702, the electronic device determines whether a first packet supports privacy preservation based on a first packet header of the first packet. For example, the determination may be based on the bits shown in FIGS. 4A-4C.

At reference 704, the electronic device identifies one or more operations to be performed on the first packet corresponding to a first privacy policy of the first packet based on the first packet upon determining that the first packet supports privacy preservation, the first privacy policy indicating a first level of data sharing privilege mapped to a first setting configured for a first user. At reference 706, the electronic device causes the one or more operations to be performed on the first packet, where the one or more operations to be performed on the first packet comprise a privacy preservation operation including implementation of a first privacy preservation protocol in the network to comply with the first level of data sharing privilege. The first privacy preservation protocol may be one of federated learning, secured MPC, PSI, differential privacy, confidential computing, homomorphic encryption, or other privacy preservation protocols.

In some embodiments, a first set of bits in the first packet header of the first packet is used to determine that the first packet supports privacy preservation, and a second set of bits in the corresponding payload of the first packet indicates the first privacy preservation protocol. The second set of bits may be bits 302 or 352 (of FIGS. 3A-3B) that map to the chosen protocols and techniques (e.g., the ones shown in FIG. 2B) in some embodiments.

In some embodiments, the second set of bits are set for the first privacy policy of the first packet based on a selection table with entries each mapping to a privacy policy. The protocol/technique selection table in FIG. 2B is an example of the selection table.

In some embodiments, identifying the one or more operations to be performed on the first packet comprises decrypting the first packet received from a second electronic device that inserts a plurality of bits mapped to the first privacy policy into the first packet. The second electronic device is the one that implements a privacy policy labeler (PPL) that inserts the privacy policy label into the first packet in some embodiments.

In some embodiments, the second electronic device further encrypts a portion of the first packet to prevent the portion of the first packet to be decrypted by the first electronic device. See box 252 of FIG. 2B for an example of the further encryption.

In some embodiments, implementing the first privacy preservation protocol comprises forwarding the first packet to a plurality of electronic devices that are qualified to implement the first privacy preservation protocol. These electronic devices are servers that meet the specific requirements for the aligning privacy computing protocols/techniques in some embodiments.

In some embodiments, the one or more operations further comprise removing information that the first user has no privilege to share. Such information includes a bystander's information as discussed herein above.

In some embodiments, the operations further comprise that the electronic device determines that a second packet includes no bits that indicate a privacy policy at reference 708, and the electronic device inserts a plurality of bits that indicate a second level of data sharing privilege into the second packet based on a second level of data sharing privilege mapped to a second setting configured for a second user at reference 710. In some embodiments, the plurality of bits indicates a second privacy preservation protocol to be implemented in the network to comply with the second level of data sharing privilege. In these operations, the electronic device operates as a privacy policy labeler (PPL) that inserts the privacy policy label mapped to the second user preference.

In some embodiments, the operations further comprise that the electronic device identifies one or more operations to be performed on a third packet corresponding to a third privacy policy of a third packet based on the third packet at reference 712, the third privacy policy indicating a third level of data sharing privilege mapped to a third setting configured for a third user, and the one or more operations are to audit one or more privacy preservation operations that have performed on the third packet; and the electronic device indicates that third packet complies with the third privacy policy upon determining that the one or more privacy preservation operations on the third packet are in compliance with the third privacy policy at reference 714. The operations include packet distribution and/or processing as discussed herein above.

In some embodiments, the indication is inserted into the third packet header of the third packet. Such indication is shown in examples of FIGS. 4A-4C.

In some embodiments, the third packet is discarded upon determining that the one or more privacy preservation operations on the third packet have violated the third privacy policy. The operations include packet distribution and/or processing as discussed herein above.

### Devices Implementing Embodiments of the Invention

FIG. 8 illustrates an electronic device implementing privacy enhancement per some embodiments. The electronic device may be a host in a cloud system, or a network node/UE in a wireless/wireline network, and the operating environment and further embodiments the host, the network node, the UE are discussed in more details herein below relating to FIGS. 9 to 14. The electronic device 802 may be implemented using custom application-specific integrated-circuits (ASICs) as processors and a special-purpose operating system (OS), or common off-the-shelf (COTS) processors and a standard OS. In some embodiments, the electronic device 802 implements one or more of the privacy policy labeler 652, the privacy compute coordinator 654, and the privacy auditor 656 discussed herein above.

The electronic device 802 includes hardware 840 comprising a set of one or more processors 842 (which are typically COTS processors or processor cores or ASICs) and physical NIs 846, as well as non-transitory machine-readable storage media 849 having stored therein software 850. During operation, the one or more processors 842 may execute the software 850 to instantiate one or more sets of one or more applications 864A-R. While one embodiment does not implement virtualization, alternative embodiments may use different forms of virtualization. For example, in one such alternative embodiment, the virtualization layer 854 represents the kernel of an operating system (or a shim executing on a base operating system) that allows for the creation of multiple instances 862A-R called software containers that may each be used to execute one (or more) of the sets of applications 864A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 854 represents a hypervisor (sometimes referred to as a virtual machine monitor (VMM)) or a hypervisor executing on top of a host operating system, and each of the sets of applications 864A-R run on top of a guest operating system within an instance 862A-R called a virtual machine (which may in some cases be considered a tightly isolated form of software container) that run on top of the hypervisor-the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 840, directly on a hypervisor (in which case the unikernel is sometimes described as running within a LibOS virtual machine), or in a software container, embodiments can be implemented fully with unikernels running directly on a hypervisor represented by virtualization layer 854, unikernels running within software containers represented by instances 862A-R, or as a combination of unikernels and the above-described techniques (e.g., unikernels and virtual machines both run directly on a hypervisor, unikernels, and sets of applications that are run in different software containers).

The software 850 contains the privacy policy labeler 652, the privacy compute coordinator 654, and the privacy auditor 656 that perform operations described with reference to operations as discussed relating to FIGS. 1 to 7. The privacy policy labeler 652, the privacy compute coordinator 654, and the privacy auditor 656 may be instantiated within the applications 864A-R. The instantiation of the one or more sets of one or more applications 864A-R, as well as virtualization if implemented, are collectively referred to as software instance(s) 852. Each set of applications 864A-R, corresponding virtualization construct (e.g., instance 862A-R) if implemented, and that part of the hardware 840 that executes them (be it hardware dedicated to that execution and/or time slices of hardware temporally shared), forms a separate virtual electronic device 860A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 844. The physical network interface 846 may include one or more antenna of the electronic device 802. An antenna port may or may not correspond to a physical antenna. The antenna comprises one or more radio interfaces.

### A Wireless Network Per Some Embodiments

FIG. 9 illustrates an example of a communication system 900 per some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3^{rd} Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902 and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub-that is, a hub whose primary function is to route communications to/from the UEs from/to the network node 910b. In other embodiments, the hub 914 may be a non-dedicated hub-that is, a device which is capable of operating to route communications between the UEs and network node 910b, but which is additionally capable of operating as a communication start and/or end point for certain data channels.

### UE Per Some Embodiments

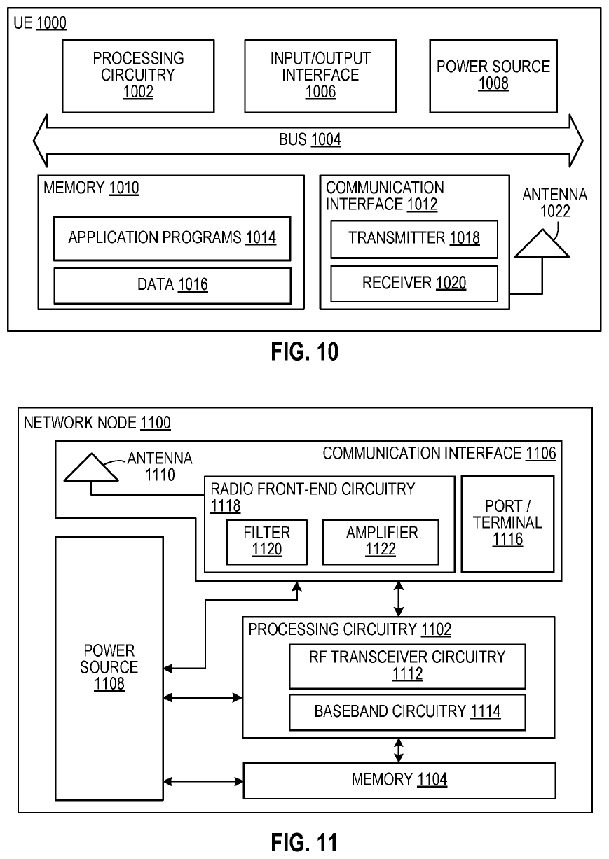

FIG. 10 illustrates a UE 1000 per some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random-access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node Per Some Embodiments

FIG. 11 illustrates a network node 1100 per some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

### Host Per Some Embodiments

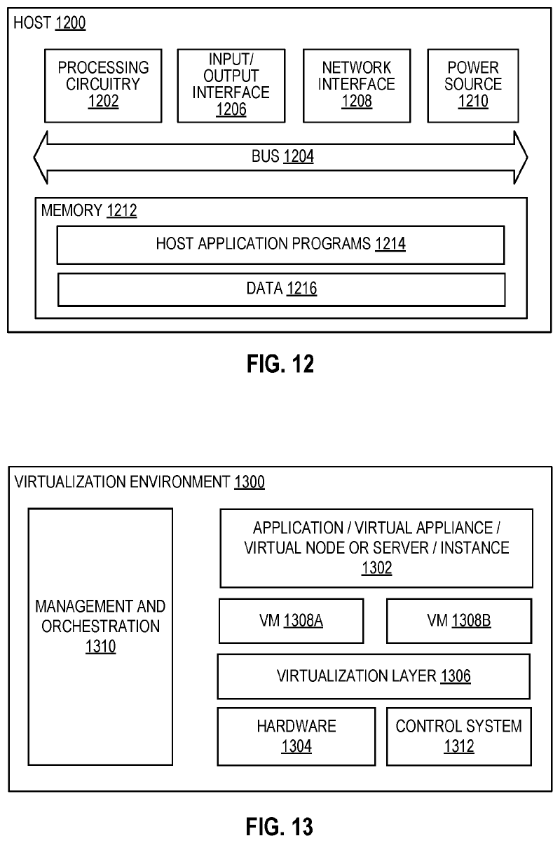

FIG. 12 is a block diagram of a host 1200, which may be an embodiment of the host 916 of FIG. 9, per various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment Per Some Embodiments

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization.

Alternatively, hardware 1304 may be part of a larger cluster of hardware (e.g., such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

### Communication among host, network node, and UE per Some Embodiments

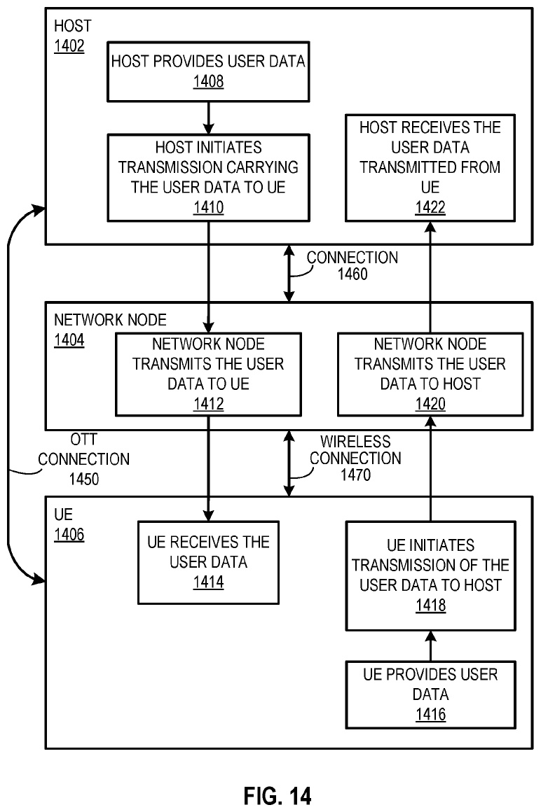

FIG. 14 illustrates a communication diagram of a host 1402 communicating via a network node 1404 with a UE 1406 over a partially wireless connection per some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein.

Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### Terms

An electronic device, such as electronic device 1102 and one of the computing devices discussed herein, stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals—such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general-purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to be implemented in a first electronic device to enhance privacy in a network, comprising:
determining whether a first packet supports privacy preservation based on a first packet header of the first packet;
identifying one or more operations to be performed on the first packet corresponding to a first privacy policy of the first packet based on the first packet upon determining that the first packet supports privacy preservation, the first privacy policy indicating a first level of data sharing privilege mapped to a first setting configured for a first user; and
causing the one or more operations to be performed on the first packet, wherein the one or more operations to be performed on the first packet comprise a privacy preservation operation including implementation of a first privacy preservation protocol for the first packet in the network to comply with the first level of data sharing privilege.

2. The method of claim 1, wherein a first set of bits in the first packet header of the first packet is used to determine that the first packet supports privacy preservation, and wherein a second set of bits in a corresponding payload of the first packet indicates the first privacy preservation protocol.

3. (canceled)

4. The method of claim 1, wherein identifying the one or more operations to be performed on the first packet comprises decrypting the first packet received from a second electronic device that inserts a plurality of bits mapped to the first privacy policy into the first packet.

5. The method of claim 4, wherein the second electronic device further encrypts a portion of the first packet to prevent the portion of the first packet to be decrypted by the first electronic device.

6. The method of claim 1, to wherein implementing the first privacy preservation protocol comprises forwarding the first packet to a plurality of electronic devices that are qualified to implement the first privacy preservation protocol.

7. The method of claim 1, wherein the one or more operations further comprise removing information that the first user has no privilege to share.

8. The method of claim 1, further comprising:
determining that a second packet includes no bits that indicate a privacy policy; and
inserting a plurality of bits that indicate a second level of data sharing privilege into the second packet based on the second level of data sharing privilege mapped to a second setting configured for a second user.

9. The method of claim 8, wherein the plurality of bits indicates a second privacy preservation protocol to be implemented in the network to comply with the second level of data sharing privilege.

10. The method of claim 1, further comprising:
identifying one or more operations to be performed on a third packet corresponding to a third privacy policy of the third packet based on the third packet, the third privacy policy indicating a third level of data sharing privilege mapped to a third setting configured for a third user, wherein the one or more operations are to audit one or more privacy preservation operations that have performed on the third packet; and
indicating that the third packet complies with the third privacy policy upon determining that the one or more privacy preservation operations on the third packet are in compliance with the third privacy policy.

11. (canceled)

12. (canceled)

13. An electronic device, comprising:
a processor and machine-readable storage medium that provides instructions that, when executed by the processor, are capable of causing the processor to perform:
determining whether a first packet supports privacy preservation based on a first packet header of the first packet;
identifying one or more operations to be performed on the first packet corresponding to a first privacy policy of the first packet based on the first packet upon determining that the first packet supports privacy preservation, the first privacy policy indicating a first level of data sharing privilege mapped to a first setting configured for a first user; and
causing the one or more operations to be performed on the first packet, wherein the one or more operations to be performed on the first packet comprises a privacy preservation operation including implementation of a first privacy preservation protocol for the first packet in the a network to comply with the first level of data sharing privilege.

14. The electronic device of claim 13, wherein a first set of bits in the first packet header of the first packet is used to determine that the first packet supports privacy preservation, and wherein a second set of bits in a corresponding payload of the first packet indicates the first privacy preservation protocol.

15. The electronic device of claim 14, wherein the second set of bits are set for the first privacy policy of the first packet based on a selection table with entries each mapping to a privacy policy.

16. The electronic device of claim 13, wherein implementing the first privacy preservation protocol comprises forwarding the first packet to a plurality of electronic devices that are qualified to implement the first privacy preservation protocol.

17. The electronic device of any claim 13, wherein the one or more operations further comprise removing information that the first user has no privilege to share.

18. The electronic device of claim 13, wherein the instructions when executed by the processor, are capable of causing the processor to further perform:
determining that a second packet includes no bits that indicate a privacy policy; and
inserting a plurality of bits that indicate a second level of data sharing privilege into the second packet based on the second level of data sharing privilege mapped to a second setting configured for a second user.

19. The electronic device of claim 18, wherein the plurality of bits indicates a second privacy preservation protocol to be implemented in the network to comply with the second level of data sharing privilege.

20. The electronic device of claim 13, wherein the instructions when executed by the processor, are capable of causing the processor to further perform:
identifying one or more operations to be performed on a third packet corresponding to a third privacy policy of the third packet based on the third packet, the third privacy policy indicating a third level of data sharing privilege mapped to a third setting configured for a third user, and wherein the one or more operations are to audit one or more privacy preservation operations that have performed on the third packet; and
indicating that the third packet complies with the third privacy policy upon determining that the one or more privacy preservation operations on the third packet are in compliance with the third privacy policy.

21. The electronic device of claim 20, wherein the indication is inserted into packet header of the third packet.

22. The electronic device of claim 20, wherein the third packet is discarded upon determining that the one or more privacy preservation operations on the third packet have violated the third privacy policy.

23. A non-transitory machine-readable storage medium that provides instructions that, when executed by a processor, are capable of causing the processor to perform:
determining whether a first packet supports privacy preservation based on a first packet header of the first packet in a network;
identifying one or more operations to be performed on the first packet corresponding to a first privacy policy of the first packet based on the first packet upon determining that the first packet supports privacy preservation, the first privacy policy indicating a first level of data sharing privilege mapped to a first setting configured for a first user; and
causing the one or more operations to be performed on the first packet, wherein the one or more operations to be performed on the first packet comprise a privacy preservation operation including implementation of a first privacy preservation protocol for the first packet in the network to comply with the first level of data sharing privilege.
